(19) United States
(12) Patent Application Publication
(10) Pub. No.: US 2026/0367670 A1
(43) Pub. Date: Nov. 19, 2026

(54) MODULAR ACCESSORY SYSTEM FOR PERSONAL COMPUTING DEVICES INCLUDING BOTH POWER AND DATA CONNECTIONS

(71) Applicant: Raven Resonance Inc., San Francisco, CA (US)

(72) Inventors: Ivan France, Saratoga, CA (US); Curtis Aumiller, San Jose, CA (US); Thomas Suarez, San Francisco, CA (US)

(73) Assignee: Raven Resonance Inc., San Francisco, CA (US)

(21) Appl. No.: 19/676,615

(22) Filed: May 13, 2026

Related U.S. Application Data
(60) Provisional application No. 63/806,454, filed on May 15, 2025.

(51) Int. Cl. G06F 1/16

(52) U.S. Cl. CPC G06F 1/1635; G06F 1/163

(57) ABSTRACT

A modular accessory system for personal computing devices having an accessory interface with at least one power and one data connection terminal, with one or more modular accessories configured to be selectively and removably attached to the personal computing device through the accessory interface. Each modular accessory having on-board memory storing data associated with the modular accessory and at least one processor configured to communicate the stored data to the personal computing device. The personal computing device is smart glasses and the modular accessories are of a type comprising a battery module, a GPS module, a camera module, a microphone module, an activity tracker module, and/or a health monitoring module. A smart glasses system with modular batteries includes smart glasses, a case, and a charging cradle for recharging the modular batteries in or out of the case.

### RELATED APPLICATION

This patent application relates to and claims priority from U.S. Provisional Patent Application No. 63/806,454 entitled “Modular Accessory System for Personal Computing Devices Including Both Power and Data Connections” filed 5/15/2025 and is incorporated herein by reference including its specification.

### FIELD OF THE INVENTION

The present invention is directed to a modular accessory system for personal computing and similar devices. The inventive modular accessory system preferably includes one or more detachable accessory modules with connections allowing for both power transfer and data transfer. The accessory modules are most preferably physically connected to the computing devices either by magnets or some other mechanical locking mechanism. Through such physical connection, the accessory modules are connected to the internal circuitry of the computing devices via induction or exposed pins – such as pogo or spring-loaded pins.

### BACKGROUND OF THE INVENTION

Personal computing devices come in many forms and functions. For example, personal computing devices may be wearable electronic devices, such as smart glasses, smart watches, and other devices that attach to or are worn by a user. In addition, personal computing devices may come in other non-wearable forms, such as GPS devices, cameras, microphones, activity trackers, health monitors, etc. Regardless of the specific form, such personal computing devices have become much more common in recent years. With the increase in numbers and users, the need for powering such devices and the use of various accessories with such devices is paramount, particularly continuously powering such devices without interruption. In addition, with the increased use of accessories with such electronic devices, the monitoring and maintenance of such modular accessories is vital.

Under current technology, users often must shut-down personal computing devices and/or remove most wearable devices in order to replace or recharge the power source. For example, most wearable devices like smart glasses or smart watches must be re-charged by placing them in a docking station or similar cradle because such batteries are usually internally mounted and not easily removed. In addition, if a user wants to replace a battery on such a wearable device, the device typically needs to be shut-down or restarted, because the power needs to be completely disconnected. Similar considerations must be accounted for with other devices, such as GPS, cameras, microphones, activity trackers, health monitoring, etc., whether stand-alone or as an accessory to another device.

In addition, with the increased use of accessory modules on personal and wearable electronic devices, it has become ever more important to track type and usage characteristics of the same types of accessories. For example, for a particular rechargeable battery, important information relevant to its performance include, but is not limited to: chemistry type, energy density, cycle life, self-discharge rate, operating temperature, internal resistance, among others. Similar for other devices like GPS, cameras, microphones, activity trackers, health monitoring, etc., type and usage characteristics and data is also important.

FIG. 6 generally illustrates a graphical depiction of smart glasses using a traditional charging system or data transfer system, wherein devices like smart glasses are charged when directly connected to or in physical contact with a charging device, such as a case, or alternatively with induction or similar near-field capabilities. The smart glasses typically include internal batteries that are permanently connected, as by soldered, into the smart glasses. When contained within the case, the batteries may be charged through physical contacts or based on proximity as by a near field induction coil or similar technology. A user would not be able to use the smart glasses when charging and would have to wait until a full charge is stored or sufficient charge for the desired use were transferred.

Accordingly, there is a need for an improved accessory system for personal computing devices, particularly wearable electronic devices and related accessories, that allows for continuous, uninterrupted use during change and recharge cycles, and also allows for monitoring and tracking features and usage characteristics, and data transfer. The present invention fulfills these needs and provides other related advantages.

### SUMMARY OF THE INVENTION

The present invention has been developed in response to the present state of the art, and in particular, in response to the problems and needs in the continuous, uninterrupted use and operation of personal computing devices, particularly wearable electronic devices. Such invention relates to a system and configuration of modular accessories, including but not limited to batteries, that allow for replacement or “hot-swapping” of one or more accessories while the electronic device is in continuous use or operation. In particular, for smart glasses or similar wearable electronic devices, a system of batteries and power management that allows for replacing a depleted (or nearly depleted) battery with a fully charged battery without interruption of operation or even use of the wearable devices, i.e., while wearing the smart glasses. Similarly, for other personal computing devices or accessory modules that function with wearable electronic devices, a similar switching or replacement of accessories without interruption of operation or use is achievable.

For example, when such modular accessories are rechargeable batteries, each modular battery can be located anywhere on the personal computing device. In the case of wearable devices like smart glasses, one or more batteries may be attached to the stems or temple arms of the glasses, i.e., behind the ear, one on each stem. Such attachment may be either mechanically or magnetically. Each modular battery can be added or removed by a user at-will and in a “hot-swappable” fashion, meaning the device can keep itself powered on even when one modular battery is disconnected. This “hot-swappable” feature may be achieved by only disconnecting one battery at a time or by incorporating a capacitor or other short-term storage capacitor internal to the wearable device. Similarly, such “hot-swappable” modular batteries may also be configured to work with stand-alone personal computing devices, like GPS devices, cameras, microphones, activity trackers, health monitors, and similar devices. In addition, with wearable devices like smart glasses or smart watches, the modular accessory system may include not only modular batteries but also modular accessories that add functionality such as GPS modules, camera modules, microphone modules, activity tracker modules, and health monitor modules, among many others.

The modular batteries can be removed and charged external to the personal computing devices, allowing modular batteries to be quickly swapped out without requiring the user to shut-down or switch to a different personal computing device. For example, when the device is a pair of smart glasses, this may mean uninterrupted work or other usage, as well as continued utilization of prescription lenses, hearing assistance, or similar features. When removed or swapped, the modular batteries may be recharged in a pocket-sized carrying charging case, as opposed to the entire case or docking station for the complete glasses frame. Alternatively, the modular batteries may be charged on a base station or similar platform.

Each modular battery and its point of connection to the personal computing device preferably has multiple connection terminals, providing both power connections, as well as additional general purpose data connections. The modular batteries include an assembly of circuitry, battery storage cells, on-board memory, and additional hardware for unique functionality used to expand the capabilities by integrating new functionality into the modular batteries themselves. The power connections preferably include a minimum of two contacts – one for power and one for ground. The data connections are preferably one or more contacts that can access, among other components, the on-board memory capable of storing data relevant to the module. For example, with a modular battery, the stored data may identify a particular battery, the chemistry type (i.e., lithium-ion, nickel-metal hydride, lead-acid, etc.), the energy density (i.e., how much energy the battery can store), the cycle life (i.e., how many complete charge-discharge cycles are possible before capacity degrades to less than 80% of original capacity), the self-discharge rate (i.e., how quickly a charge dissipates when not in use), the charge/discharge rate during usage, the operating temperature, the internal resistance, the actual charging cycles, and to authenticate supported battery hardware.

As mentioned above, in addition to modular batteries, the inventive modular system also contemplates accessories such as GPS modules, camera modules, microphone modules, activity tracker modules, and health monitoring modules, among others. With such modular accessories, each may include its own on-board battery that may be recharged in a similar manner to that described above for the modular batteries. Alternatively, the personal computing device may be configured to charge an accessory module from a modular battery also attached to the same personal computing device. For example, with smart glasses, one temple arm might include a battery module and the second temple arm might include one of the other accessory modules (GPS, camera, microphone, activity tracker, health monitor, etc.), with the smart glasses configured to conduct power from the battery module to the other accessory module for powering operation. In this configuration, it is important to have a capacitor or other short-term power storage device in the smart glasses to maintain continuous and uninterrupted operation when swapping a single modular battery on the personal computing device.

For modular batteries, the monitoring and maintenance of the same might include data storage and transmission of module identification, usage management, and tracking of battery data, i.e., percentage of discharge and number of recharge cycles. When other modular accessories include devices like GPS modules, camera modules, microphone modules, activity tracker modules, health monitoring modules, etc., different data is important for monitoring and maintenance. Regardless of the type of monitoring and maintenance, the accessory module includes on-board memory and corresponding sensors and processors to collect and record the relevant data.

Such accessory modules, whether batteries or another type, must be physically connected to the personal computing device for power transmission. Such physical connection is preferably by induction or exposed pins, i.e., pogo or spring-loaded pins. The same types of physical connections may also be used for data transmission. Alternatively, such data transmission may occur wirelessly with the personal computing devices or an associated smart phone.

Examples of additional functionality for use with modular accessories within this system, might include: (1) accessory modules with various input-output options, i.e., USB-C, SD card, headphone jack, buttons, scroll wheel, touch inputs, haptic actuators, microphones, or camera; (2) accessory modules with expanded device capabilities or sensors, expandable storage or memory, extended range antenna for Bluetooth or wi-fi, satellite (GNSS) positioning, or other wireless communication; or (3) accessory modules with pinouts in several forms – ideally about 6-8 pins for power, data, and several additional sensor and communications pins.

In a particular embodiment, the present invention is directed to a modular accessory system for a personal computing device. The modular system includes at least a personal computing device having an accessory interface with a plurality of connection terminals – at least one power connection terminal and at least one data connection terminal. The system also includes one or more modular accessories configured to be selectively and removably attached to the personal computing device through the accessory interface, each modular accessory including circuitry configured to electrically connect the modular accessory to the personal computing device through the plurality of connection terminals, on-board memory configured to store data associated with the modular accessory, and at least one processor configured to communicate the stored data to the personal computing device via the at least one data connection terminal.

The personal computing device may be a wearable electronic device, preferably a pair of smart glasses having at least one temple arm, wherein the one or more modular accessories are configured to attach to the at least one temple arm. The one or more modular accessories are preferably of a type comprising at least one of a battery module, a GPS module, a camera module, a microphone module, an activity tracker module, and/or a health monitoring module. Depending on the type of modular accessory, the stored data thereon preferably consists of operational data specific to the type of modular accessory, consisting of at least one of battery heath data for a battery module, location history data for a GPS module, activity data for an activity tracker module, audio/video data for a camera module, audio data for a microphone module, and/or health metric data for a health monitoring module.

Each modular accessory is preferably configured to be selectively attached to and removed from the personal computing device using at least one of a magnetic attachment mechanism or a mechanical locking mechanism. The plurality of connection terminals preferably includes between six and eight pins providing connections for power, ground, data, and at least one of sensor communications or processor communications. In addition, the plurality of connection terminals preferably includes at least one of induction-based connections and/or exposed conductive pins, wherein the exposed conductive pins may consist of pogo pins or spring-loaded pins. The data communication between the modular accessory and the personal computing device may also be achieved or performed wirelessly.

In a further embodiment, the present invention is directed to a modular battery system for a personal computing device, where the personal computing device has a power management circuit and an accessory interface having a plurality of connection terminals including at least one power connection terminal and at least one data connection terminal. The modular battery system preferably includes one or more modular batteries that are removable, rechargeable configured to be selectively attached to and detached from the personal computing device by the accessory interface. Such selective attachment and detachment is preferably accomplished without interrupting operation of the personal computing device.

Each modular battery preferably includes one or more battery storage cells, circuitry configured to electrically connect the modular battery to the personal computing device through the plurality of connection terminals, on-board memory configured to store battery health data including at least one of battery identification, chemistry type, energy density, cycle life, self-discharge rate, charge or discharge rate, operating temperature, internal resistance, or actual charge cycle count, and at least one processor configured to communicate the battery health data to the power management circuit of the personal computing device via the at least one data connection terminal.

In such modular battery system, the personal computing device is preferably a wearable electronic device. The power management circuit is preferably configured to draw power from each of a plurality of modular batteries alternately to deplete the modular batteries in a substantially uniform manner. In addition, the power management circuit may be configured to prevent depleting any one modular battery below a predetermined charge threshold until at least one other modular battery of the plurality of modular batteries is substantially depleted.

The power management circuit may be configured to recommend battery management actions to a user based on the battery health data contained in the memory of the one or more modular batteries, wherein the battery management actions include at least one of swapping modular batteries or balancing charge cycles across modular batteries. The on-board memory may further store authentication data configured to verify that the modular battery is a supported and compatible modular battery for the personal computing device. Each modular battery is preferably configured to be recharged in a portable charging cradle external to the personal computing device.

In a still further embodiment, the present invention is directed to a smart glasses system with modular battery accessories. The system includes a pair of smart glasses having a frame and at least one temple arm, and including a power management circuit and an accessory interface on the at least one temple arm. The accessory interface preferably has a plurality of connection terminals including at least two power connection terminals and at least one data connection terminal. One or more modular battery accessories are configured to be selectively and removably attached to the accessory interface on the at least one temple arm without interrupting operation of the smart glasses. Each modular battery accessory includes one or more rechargeable battery storage cells, a printed circuit board comprising a microcontroller and a fuel gauge integrated circuit, on-board memory configured to store battery health data, and circuitry configured to communicate the battery health data to the power management circuit via the at least one data connection terminal. The power management circuit is configured to maintain continuous and uninterrupted operation of the smart glasses during removal and replacement of any one of the one or more modular battery accessories.

The smart glasses system further includes back-up power source such as a capacitor, a lithium battery cell with a high discharge rate, or another temporary power storage device internal to the smart glasses configured to maintain power to the smart glasses during removal and replacement of any one of the modular battery accessories. The battery health data preferably includes battery identification, chemistry type, energy density, cycle life, self-discharge rate, charge or discharge rate, operating temperature, internal resistance, and actual charge cycle count. The power management circuit is configured to communicate the battery health data to a smartphone or other external computing device for monitoring, maintenance, and/or management of the one or more modular battery accessories.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is a perspective, solid-form view of an embodiment of a personal computing device, e.g., smart glasses, embodying the present invention;

FIG. 2 is a top plan, view of the smart glasses of FIG. 1;

FIG. 3 is a close-up perspective view of an accessory module, e.g., proximate to a temple arm of the smart glasses according to the present invention;

FIG. 4 is a perspective view of the smart glasses of FIG. 1, showing a first accessory module attached to a temple arm and a second accessory spaced apart from another temple arm;

FIG. 5 is a system view of a modular case, battery housing, and smart glasses;

FIG. 6 generally illustrates a prior art charging system for smart glasses.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element’s relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes and configurations of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention described herein is primarily concerned with the power supply and operation of modular accessories used in personal computing devices such as wearable electronic devices or smart glasses and similar wearable technology. This disclosure is not necessarily concerned with the function and operation of the personal computing devices beyond the power supply and operation of related accessories. Features such as display, audio/video, data communication, and control of such devices are intended to conform to the current state of the art of such features, or as such state of the art may develop in the future.

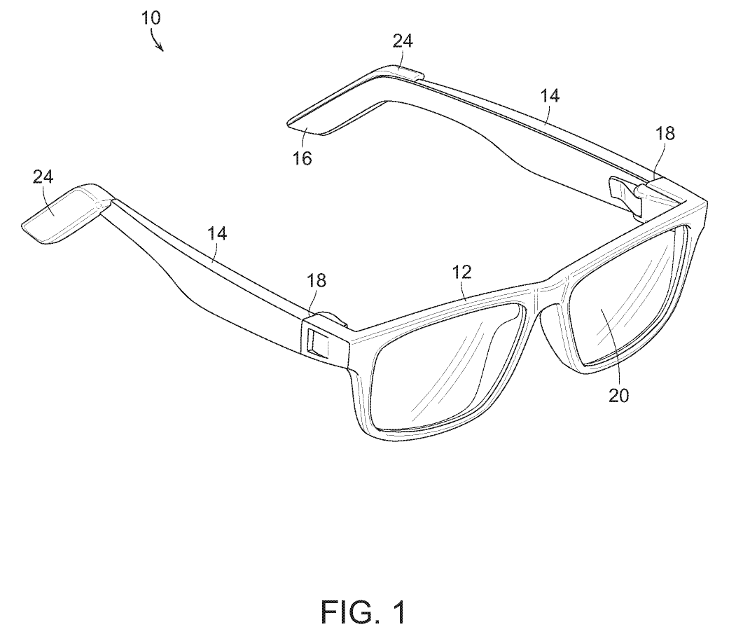

The present invention is directed to a system of modular accessories for personal computing devices. FIGS. 1-5 generally show the personal computing or wearable electronic device as smart glasses, including swappable modular accessories in the form of batteries. While the following description primarily focuses on smart glasses and related modular accessories, the modular system of the present invention has broader application for accessories that are used with a variety of personal computing devices.

In the embodiments described herein, the electronic devices are described as smart glasses, but may also comprise other forms of stand-alone personal or wearable computing devices, including but not limited to GPS devices, cameras, microphones, activity trackers, health monitors, and similar devices. Similarly, while the embodiments of modular accessories are primarily described as swappable batteries, they may also comprise other modules, including but not limited to GPS modules, camera modules, microphone modules, activity tracker modules, and health monitor modules.

Further, the present invention is concerned with a modular accessory system, including power supply devices, for personal computing devices, including wearable devices such as smart glasses, wherein the power supply device or apparatus provides one or more battery modules that are selectively removable from the wearable device in a manner where the device is continuously powered and/or usable, including during recharging, replacement, or hot-swapping of one or more of the battery modules. In this system, each of the modular accessories – whether battery modules, GPS modules, camera modules, microphone modules, activity tracker modules, health monitoring modules, etc. – preferably includes one or more general purpose data connections as further described below. The terms “battery module” and “modular battery” (including plurals of the same) are used interchangeably throughout this written description and are intended to mean and refer to the same parts.

The modular accessories are preferably configured to be removed and/or replaced on the personal computing device without interrupting operation or requiring shut-down of the wearable device. In particular, with battery modules, the inventive power supply system is configured such that the power stored in one or more batteries is selectively depleted in a manner so as to optimize battery life, such as by minimizing depleting/recharging cycles and/or fully depleting a single battery of charge. Through such configuration, the battery modules maintain sufficient charge for steady reliable operation of the wearable device by maintaining a minimum charge in one or more battery modules – this before fully depleting one battery and/or by transferring a portion of a higher charge from one battery to another battery with a lower charge. Similarly, when the modular accessories include one battery module and one other accessory module (i.e., activity tracker), the wearable device can transfer charge from the one battery module to operate or maintain the other accessory module for steady reliable operation.

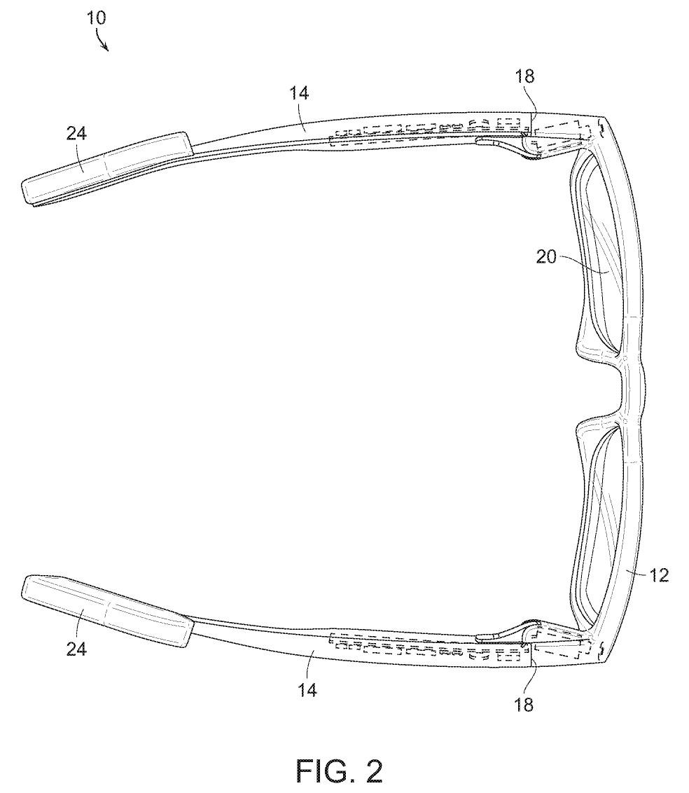

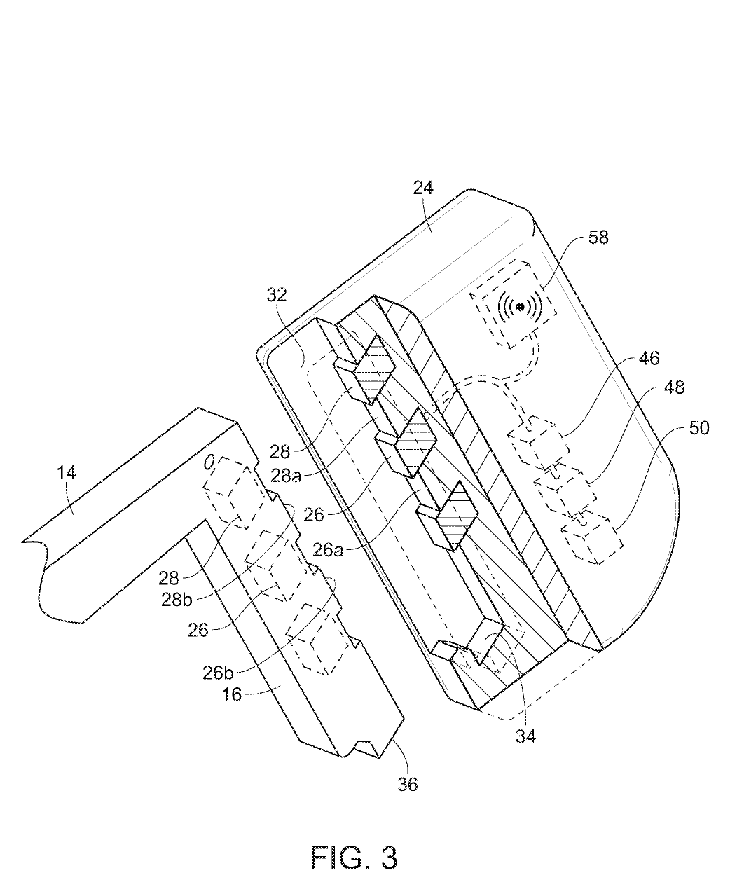

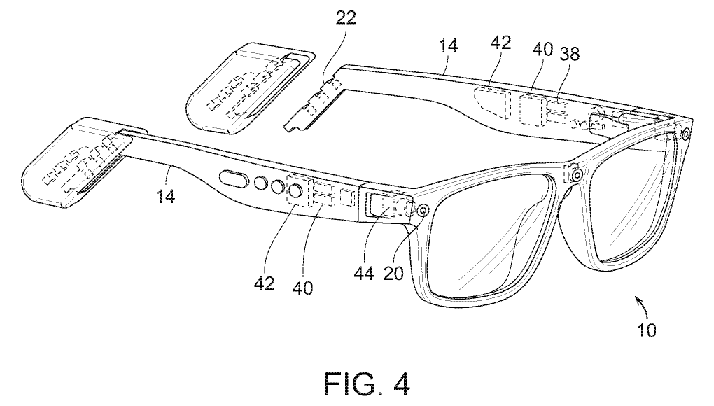

A particular embodiment of the personal or wearable computing device of the present invention is preferably in the form smart glasses 10, shown in FIGS. 1 and 2. Such smart glasses 10 have the typical features of a frame 12, temples or temple arms 14, temple tips 16, hinges 18, and lenses 20. In this embodiment, the temple tips 16 are preferably configured with battery receptacles 22 that receive battery modules 24. FIGS. 3 and 4 illustrate an embodiment where the battery modules 24 engage the temple tips 16, wherein the extreme ends of the temple tips 16 are configured to be inserted into a groove 32 on the battery module 24. The groove 32 has a depth configured to accept a sufficient portion of the temple tip 16 to provide stability to the connection. FIG. 3 shows in close-up the battery module 24 in spaced relation to the temple tip 16. FIG. 4 shows alternately one battery module 24 connected to the temple tip 16 and another battery module 24 in spaced relation to the other temple tip 16.

Corresponding elements of contacts 26 and 28 (electrical and/or physical contacts) are shown in schematic representations on the end of the temple tip 16 and in the slot 32 of the battery module 24. Such contacts 26 and 28 being in one or more form of mechanical, magnetic, inductive, conductive, or other known form of connection or attraction to achieve electrical and physical connection. In one embodiment, shown in FIG. 3, the corresponding electrical contacts 26 and physical contacts 28 preferably have mating recesses 26a/28a and extensions 26b/28b, that increase surface contact for improved electrical and physical connection. In addition, the groove 32 in each embodiment includes a notch 34 configured to receive a corresponding tab 36 on the temple tip 16 to provide additional securement and attachment.

In this embodiment shown in FIGS. 3 and 4, the battery module 24 engages and remains on the receptacle 22 from a posterior side, e.g., an end surface of the temple tips 16 extending along a portion of the temple tip 16 that is often positioned behind a user’s ear when worn – adding length to the temple arms 14. Alternatively, as shown in FIGS. 1 and 2, the battery module 24 and receptacle 22 are configured such that the same may engage and remain connected on a lateral side thereof, e.g., an inside or outside surface of the temple tip 16 extending toward or away from a center line of the frame 12. There is preferably a receptacle 22 and a corresponding battery 24 included on the temple tip 16 of each temple arm 14. In the embodiment shown, the form of the electrical contacts 26 and physical contacts 28 are schematically represented and understood to comprise one of the foregoing described forms.

FIG. 4 further illustrates a partially transparent view of the smart glasses 10 showing computing circuity 38, a power management circuit (PMC) 40, a back-up power source 42 and other elements contained within the frame 12 and/or temple arms 14. The back-up power source 42 preferably includes a capacitor, a lithium battery cell with a high discharge rate, or another temporary power storage device internal to the smart glasses configured to maintain power to the smart glasses during removal and replacement of any one of the modular battery accessories 24. One such other element might include a camera 44, preferably disposed in the hinge 18 or front surface of the frame 12, adjacent to a lens 20. Although not shown in complete detail, it is understood that the computing circuity 38, power management circuit (PMC) 40, back-up power source 42 and other elements are internally connected by conductive wiring or similar technology, including connecting the PMC 40 to the electrical contacts 26 of the receptacles 22 on the temple tips 16.

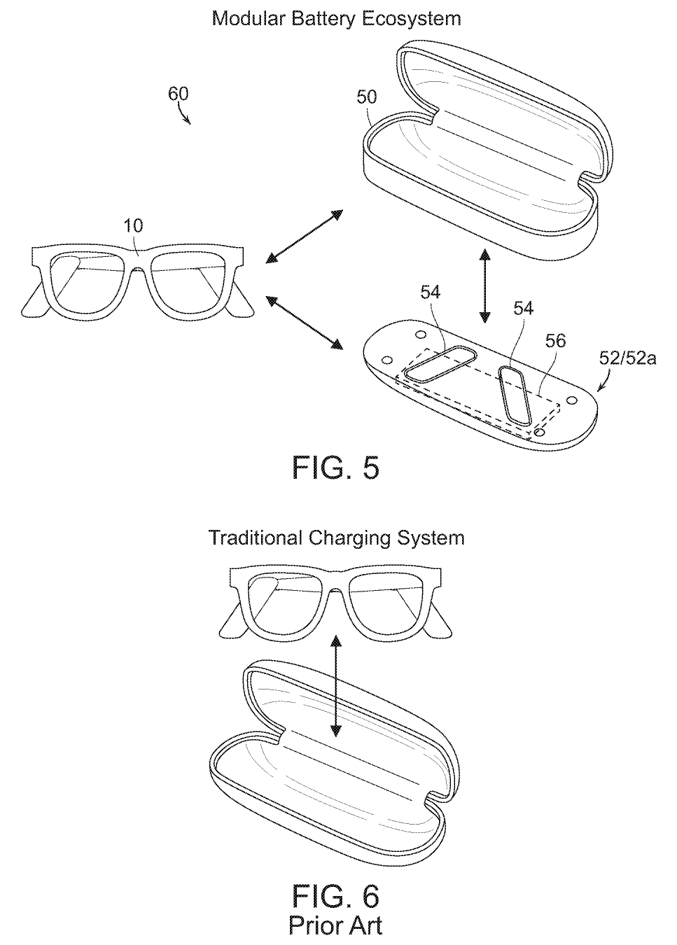

FIG. 5 illustrates an embodiment of a modular battery system (e.g., ecosystem) 60 for personal and wearable electronic devices of the type described herein that includes the device, a case, and an accessory cradle. The modular battery system 60 may wirelessly charge the modular batteries 24 as described above or charge the same through physical contact of electrical connections within an accessory cradle 52 removably stored in a case 50. Similarly, other accessory modules 24 may be charged (if they have on-board power storage) or otherwise transfer data regarding usage or maintenance when placed in such an accessory cradle 52. Similarly, other accessory modules 24 may also be removed and stored in a comparable case 50 or docking station/cradle 52 as described herein.

The particular embodiment shown is for use with smart glasses 10 and includes a glasses case 50 with an accessory cradle 52. The case 50 may be a simplified form of the case from the prior art, where charging or other electronic components may be independent of the case 50, preferably in the accessory cradle 52a. The accessory cradle 52a may be further described as an accessory charging cradle 52.

The accessory charging cradle 52 preferably includes two or more charging slots 54, each configured for receiving a 24 as described above, and a power storage cell 56. The power storage cell 56 is designed to hold a significant charge that can be transferred to individual modular batteries 24 placed into the charging slots 54. When placed into a charging slot 54, the modular batteries 24 may be recharged either by electrical connection with contacts 26 or 28 and corresponding contacts (not shown) in the charging slot 54 or by near-field or induction connection.

The power storage cell 56 of the charging cradle 52 can be recharged by wired connection to another power source or similarly by wireless near field or induction connection. In one embodiment, the case 50 may include electrical components – either contacts or contactless – that can recharge the power storage cell 56 when the same is positioned in the case 50.

In this configuration, two modular batteries 24 may be connected to the smart glasses 10 to provide power thereto, and two or more additional modular batteries 24 may be stored in the charging cradle 52 depending on the number of charging slots 54. When one or more of the modular batteries 24 connected to the smart glasses 10 are sufficiently depleted in charge, they may be swapped with one or more of the modular batteries 24 stored in the charging slots 54 on the charging cradle 52. In this way, the modular batteries 24 may be “hot-swapped”, meaning that one modular battery 24 may be replaced while a second modular battery 24 remains connected and powering the smart glasses 10 until a replacement modular battery 24 is connected. The “hot-swapping” system is designed to keep the smart glasses consistently powered and operational.

In addition to maintaining consistent power and operation of the smart glasses 10, another primary benefit of the swappable modular batteries is the preservation of battery lifetime. There can be multiple modular batteries 24 connected to a given personal computing device at any given time. Each of such multiple modular batteries 24 can have varying voltages depending upon how much charge each has at a given moment and its number of historical charge cycles, i.e., how many times a battery has been charged and discharged. Each modular battery 24 may be connected to its own small-printed circuit board (PCB) with a microcontroller and “fuel gauge” integrated circuit (IC) that tracks the cycles of that particular modular battery 24 by saving the information to EEPROM or other on-board memory storage. This configuration provides data to the power management circuit (PMC) 40 over a suitable digital connection (I2C or similar) and allows for setting recommendations to the user. For example, with smart glasses, if a user repeatedly changes only one modular battery 24, e.g., the right one, when the charge gets low, but rarely changes the other modular battery 24, the PMC 40 of the device may recommend the user to swap left and right modular batteries 24 to better balance the operation for uniform charge and cycles, i.e., wear and tear.

The PMC 40 may be set into a "battery lifespan extending" mode, in multiple ways. The PCB 40 and an IC “fuel gauge” may automatically set such mode. Alternatively, a processor 38 on the main device (e.g. smart glasses 10) may command the PMC 40 to set such mode. Such a main device processor may be part of an IC separate from the PMC – or the main device processor can itself be the PMC in a unified implementation. Further, the user may manually set such operation mode in the software settings. Such a “battery lifespan extending” mode would preferably draw power from each modular battery 24 alternately and equally to deplete them both more uniformly, switching periodically or drawing in parallel. Such mode might alternatively prevent depleting one modular battery 24 below a pre-determined threshold until all available power from the other modular battery 24 is depleted. For example, assuming both modular batteries 24 start at 100%, the system may be configured to use both modular batteries 24 down to 25% before continuing to use one modular battery 24 one down to 0% and then switching to the other modular battery 24. Such configuration prolongs the time before a single modular battery 24 is depleted below a point that would otherwise diminish its lifetime capacity or functionality.

Each modular accessory – whether battery or other – preferably has at its point of connection to the personal computing device multiple connection terminals, providing both power connections and additional general purpose data connections. FIGS. 3 and 4 show one preferred embodiment, in particular for use with smart glasses, schematically depicting three connection nodes within the modular accessory 24, adjacent to the side of the housing that connects to the smart glasses temple tip 16. The modular accessories 24 preferably include an assembly of circuitry 46, power storage cells 47, on-board memory 48, and additional hardware for unique functionality used to expand the capabilities by integrating new functionality into the modular accessories 24 themselves. The contacts 26 and 28 preferably include a minimum of two electrical connections – one for power and one for ground, as well as preferably at least one data connection that can access, among other components, the on-board memory 48.

The on-board memory 48 is preferably configured to store data relevant to the particular modular accessory 24 and its performance. For example, for a modular battery 24, the on-board memory 48 might identify a specific or unique battery module, the chemistry type (i.e., lithium-ion, nickel-metal hydride, lead-acid, etc.), the energy density specifications (i.e., how much energy can be stored), the life cycle parameters (i.e., how many complete charge-discharge cycles are possible before capacity degrades to less than 80% of original capacity), the self-discharge rate (i.e., how quickly a charge dissipates when not in use), the charge/discharge rate during usage, the operating temperature parameters, the internal resistance values, the actual charging cycle count, and authentication data for supported hardware. For other accessory modules, the data storage capabilities might store critical operational data, such as for GPS (location history, trip history, mode of travel, etc.), activity tracker (steps, duration, distance, frequency, etc.), for camera or microphone (video files, digital images, audio files, etc.), and for health monitoring (heart rate, blood-oxygen ratio, blood pressure, body temperature, sleep cycles, etc.).

The contacts 26 or 28 are preferably physically connected for power transmission, such as via induction or exposed pins, i.e., pogo or spring-loaded pins. Similar physical contacts 26 or 28 are preferably also used for data transmission as described. Alternatively, data transmission may occur wirelessly via antenna 58, e.g., near-field, Bluetooth, etc., with the wearable devices 10 or an associated external device, e.g., smart phone. For data transmission methods, data transmission may be wired via physical connection terminals, or optionally wireless data transmission capabilities to a wearable device (i.e., smart glasses); or associated smartphones or other compatible devices. For enhanced functionality options, the accessory modules or corresponding cases preferably include multiple input/output expansions, such as USB-C ports, SD card slots, headphone jacks, physical buttons, scroll wheels, touch input surfaces, haptic actuators, microphones, and/or cameras. In addition, extended device capabilities may include expanded storage or memory, extended-range antenna for Bluetooth or Wi-Fi, satellite (GNSS) positioning hardware, and/or additional wireless communication protocols.

Examples of additional functionality for use with different modular accessories 24 within this system, might include: (1) accessory modules with various input-output options, i.e., USB-C, SD card, headphone jack, buttons, scroll wheel, touch inputs, haptic actuators, microphones, or camera; (2) accessory modules with expanded device capabilities or sensors, expandable storage or memory, extended range antenna for Bluetooth or wi-fi, satellite (GNSS) positioning, or other wireless communication; or (3) accessory modules with pinouts in several forms – ideally about 6-8 pins for power, data, and several additional sensor and communications pins. Ideally, each connection terminal includes at least 6-8 pins in total for power, data, and additional sensor/communications functionality as may be needed or desired by the user.

The advantages of such an inventive modular accessory system 60 include: extended device functionality without significantly increasing the size of the main personal computing unit; hot-swappable power and operation solution eliminating downtime for charging or switching accessories; customizable functionality based on user needs and activities; future-proof design allowing for new module development without replacing the entire device; comprehensive accessory health monitoring and management; and/or authentication of compatible components to ensure system integrity.

Although several embodiments have been described in detail for purposes of illustration, various modifications may be made without departing from the scope and spirit of the invention.

1. A modular accessory system for a personal computing device, the system comprising:
a personal computing device having an accessory interface comprising a plurality of connection terminals including at least one power connection terminal and at least one data connection terminal; and
one or more modular accessories configured to be selectively and removably attached to the personal computing device via the accessory interface, each modular accessory comprising:
circuitry configured to electrically connect the modular accessory to the personal computing device through the plurality of connection terminals;
on-board memory configured to store data associated with the modular accessory; and
at least one processor configured to communicate the stored data to the personal computing device via the at least one data connection terminal.

2. The modular accessory system of claim 1, wherein the personal computing device is a wearable electronic device.

3. The modular accessory system of claim 2, wherein the wearable electronic device is a pair of smart glasses having at least one temple arm, wherein the one or more modular accessories are configured to attach to the at least one temple arm.

4. The modular accessory system of claim 1, wherein the one or more modular accessories comprise at least one of a battery module, a GPS module, a camera module, a microphone module, an activity tracker module, or a health monitoring module.

5. The modular accessory system of claim 4, wherein the stored data comprises operational data particular to the modular accessory, the operational data comprising at least one of: battery heath data for a battery module; location history data for a GPS module; activity data for an activity tracker module; audio/video data for a camera module; audio data for a microphone module; or health metric data for a health monitoring module.

6. The modular accessory system of claim 1, wherein each modular accessory is configured to be selectively attached to and removed from the personal computing device using at least one of a magnetic attachment mechanism or a mechanical locking mechanism.

7. The modular accessory system of claim 1, wherein the plurality of connection terminals comprise between six and eight pins providing connections for power, ground, data, and at least one of sensor communications or processor communications.

8. The modular accessory system of claim 1, wherein the plurality of connection terminals comprise at least one of induction-based connections or exposed conductive pins.

9. The modular accessory system of claim 8, wherein the exposed conductive pins comprise pogo pins or spring-loaded pins.

10. The modular accessory system of claim 1, wherein data communication between the modular accessory and the personal computing device is performed wirelessly.

11. A modular battery system for a personal computing device, the personal computing device having a power management circuit and an accessory interface comprising a plurality of connection terminals including at least one power connection terminal and at least one data connection terminal, the system comprising:
one or more modular batteries that are removable, rechargeable, and configured to be selectively attached to and detached from the personal computing device via the accessory interface without interrupting operation of the personal computing device, each modular battery comprising:
one or more battery storage cells;
circuitry configured to electrically connect the modular battery to the personal computing device through the plurality of connection terminals;
on-board memory configured to store battery health data comprising at least one of battery identification, chemistry type, energy density, cycle life, self-discharge rate, charge or discharge rate, operating temperature, internal resistance, or actual charge cycle count; and
at least one processor configured to communicate the battery health data to the power management circuit of the personal computing device via the at least one data connection terminal.

12. The modular battery system of claim 11, wherein the personal computing device is a wearable electronic device.

13. The modular battery system of claim 11, wherein the power management circuit is configured to draw power from each of a plurality of modular batteries alternately to deplete the modular batteries in a substantially uniform manner.

14. The modular battery system of claim 13, wherein the power management circuit is further configured to prevent depleting any one modular battery below a predetermined charge threshold until at least one other modular battery of the plurality of modular batteries is substantially depleted.

15. The modular battery system of claim 11, wherein the power management circuit is configured to recommend battery management actions to a user based on the battery health data communicated from the one or more modular batteries modules, wherein the battery management actions comprise at least one of swapping modular batteries or balancing charge cycles across modular batteries.

16. The modular battery system of claim 11, wherein the on-board memory further stores authentication data configured to verify that the modular battery is a supported and compatible modular battery for the personal computing device.

17. The modular battery system of claim 11, wherein each modular battery is configured to be recharged in a portable charging cradle external to the personal computing device.

18. A smart glasses system with modular battery accessories, the system comprising:
a pair of smart glasses having a frame and at least one temple arm, the smart glasses comprising a power management circuit and an accessory interface on the at least one temple arm, the accessory interface comprising a plurality of connection terminals including at least two power connection terminals and at least one data connection terminal;
one or more modular battery accessories configured to be selectively and removably attached to the accessory interface on the at least one temple arm without interrupting operation of the smart glasses, each modular battery accessory comprising:
one or more rechargeable battery storage cells;
a printed circuit board comprising a microcontroller and a fuel gauge integrated circuit;
on-board memory configured to store battery health data; and
circuitry configured to communicate the battery health data to the power management circuit via the at least one data connection terminal, wherein the power management circuit is configured to maintain continuous and uninterrupted operation of the smart glasses during removal and replacement of any one of the one or more modular battery accessories.

19. The smart glasses system of claim 18, further comprising a back-up power source internal to the smart glasses configured to maintain power to the smart glasses during removal and replacement of any one of the modular battery accessories, wherein the back-up power source comprises a capacitor, or a lithium battery cell having a high discharge rate.

20. The smart glasses system of claim 18, wherein the battery health data comprises battery identification, chemistry type, energy density, cycle life, self-discharge rate, charge or discharge rate, operating temperature, internal resistance, and actual charge cycle count, and the power management circuit is configured to communicate the battery health data to a smartphone or other external computing device for monitoring, maintenance, or management of the one or more modular battery accessories.
